(19) United States
(12) Patent Application Publication
(10) Pub. No.: US 2020/0169324 A1
(43) Pub. Date: May 28, 2020

(54) OPTICAL TRANSMISSION SYSTEM AND APPARATUS AND TRANSMISSION METHOD

(71) Applicant: FUJITSU LIMITED, Kawasaki-shi (JP)

(72) Inventors: Kunihiko YANAGIKUIDA, Kawasaki (JP); Shota Shinohara, Kawasaki (JP); Hisayuki Ojima, Kawasaki (JP); Toshihiro Suzuki, Kawasaki (JP); Taketo Endo, Kawasaki (JP); Hayato Furukawa, Kawasaki (JP)

(73) Assignee: FUJITSU LIMITED, Kawasaki-shi (JP)

(21) Appl. No.: 16/693,097

(22) Filed: Nov. 22, 2019

(30) Foreign Application Priority Data
Nov. 27, 2018 (JP) 2018-220980

(51) Int. Cl. H04B 10/50; H04J 14/02; H04J 3/16

(52) U.S. Cl. CPC H04B 10/501; H04J 14/0241; H04J 2203/0069; H04J 2203/0091; H04J 3/1664

(57) ABSTRACT

An optical transmission apparatus includes a detecting circuit configured to detect one or more empty slots in which a data signal is not accommodated in a plurality of slots included in a frame, a frame processing circuit configured to reduce size of the frame by deleting the one or more empty slots from the frame based on a detection result of the one or more empty slots and closing up gaps between remaining slots in the plurality of slots, and an optical modulation processing circuit configured to carry out multi-level modulation of the frame at a bit rate according to size of the frame after reduction.

### CROSS-REFERENCE TO RELATED APPLICATION

This application is based upon and claims the benefit of priority of the prior Japanese Patent Application No. 2018-220980, filed on Nov. 27, 2018, the entire contents of which are incorporated herein by reference.

### FIELD

The embodiments discussed herein are related to optical transmission system and apparatus and a transmission method.

### BACKGROUND

For example, the International Telecommunication Union Telecommunication Standardization Sector (ITU-T) Recommendation G.709 prescribes techniques of high-capacity optical transport network (OTN), In a transmission system based on the OTN, client signals are accommodated in a payload in an optical signal in a format referred to as the optical channel transport unit (OTU) frame and the optical signal is transmitted. Therefore, high-capacity transmission is enabled.

As related arts, for example, Japanese Laid-open Patent Publication No 2017-98844 and Japanese Laid-open Patent Publication No. 2014-123892 are disclosed.

### SUMMARY

According to an aspect of the embodiments, an optical transmission apparatus includes a detecting circuit configured to detect one or more empty slots in which a data signal is not accommodated in a plurality of slots included in a frame, a frame processing circuit configured to reduce size of the frame by deleting the one or more empty slots from the frame based on a detection result of the one or more empty slots and closing up gaps between remaining slots in the plurality of slots, and an optical modulation processing circuit configured to carry out multi-level modulation of the frame at a bit rate according to size of the frame after reduction.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a configuration diagram illustrating one example of an optical transmission system;

FIG. 2 is a configuration diagram illustrating one example of a transponder of a first embodiment;

FIG. 3 is a diagram illustrating one example of an OTUCn frame;

FIG. 4 is a diagram illustrating change in a bit rate with respect to a transmission distance in a comparative example and an embodiment;

FIG. 5 is a configuration diagram illustrating one example of functions of a transponder in an upstream direction;

FIG. 6 is a time chart illustrating one example of frame signals, clock signals, a frame pulse, and an enable signal;

FIG. 7 is a configuration diagram illustrating one example of a configuration of a frame size adjuster (FSA) chip relating to processing of an OTUCn frame in an upstream direction;

FIG. 8 is a flowchart illustrating one example of processing of an OTUCn frame in an upstream direction by an FSA chip;

FIG. 9 is a time chart illustrating one example of processing of an OTUCn frame in an upstream direction by an FSA chip;

FIG. 10 is a configuration diagram illustrating one example of functions of a transponder in a downstream direction;

FIG. 11 is a time chart illustrating one example of frame signals, clock signals, a frame pulse, and an enable signal;

FIG. 12 is a configuration diagram illustrating one example of a configuration of an FSA chip relating to processing of an OTUCn frame in a downstream direction;

FIG. 13 is a flowchart illustrating one example of processing of an OTUCn frame in a downstream direction by an FSA chip;

FIG. 14 is a time chart illustrating one example of processing of an OTUCn frame in a downstream direction by an FSA chip;

FIG. 15 is a configuration diagram illustrating one example of transponders of a second embodiment;

FIG. 16 is a configuration diagram illustrating one example of a configuration of a framer chip relating to processing of an OTUCn frame in an upstream direction;

FIG. 17 is a flowchart illustrating one example of processing of an OTUCn frame in an upstream direction by a framer chip;

FIG. 18 is a time chart illustrating one example of processing of an OTUCn frame in an upstream direction by a framer chip;

FIG. 19 is a configuration diagram illustrating one example of a configuration of a framer chip relating to processing of an OTUCn frame in a downstream direction;

FIG. 20 is a flowchart illustrating one example of processing of an OTUCn frame in a downstream direction by a framer chip; and

FIG. 21 is a time chart illustrating one example of processing of an OTUCn frame in a downstream direction by a framer chip.

### DESCRIPTION OF EMBODIMENTS

In ITU-T Recommendation G.709, the OTUCn frame that arises from extension of the OTU frame and has a bit rate of 100 Gbps×n (n: positive integer) is prescribed in order to flexibly accommodate data beyond 100 Gbps. The size of the OTUCn is 3824×n×4 (Byte) according to the positive integer n.

In the case of transmitting the OTUCn frame, for example, when a modulation system of any of quadrature phase shift keying (QPSK), 16 quadrature amplitude modulation (QAM), and 64 QAM is used, the OTUCn frame may be efficiently transmitted because the respective bit rates are 100 Gbps, 200 Gbps, and 400 Gbps, respectively.

However, the transmission distance becomes shorter when the multi-level degree of the modulation system is higher. For example, if the transmission distance of 16 QAM is not permitted when the bit rate of the OTUCn frame is 200 Gbps (n=2), it is possible to extend the transmission distance by using QPSK, which has a lower multi-level degree than 16 QAM. However, in this case, the bit rate decreases to 100 Gbps, which is half the bit rate in the case of 16 QAM.

In contrast, according to a technique of probabilistic shaping (PS) (hereinafter, represented as “PS technique”), the bit rate of the multi-level modulation may be changed with fine granularity in a range of 100 Gbps to 200 Gbps, for example, may be changed to 110 Gbps and 120 Gbps. Thus, the transmission distance may also be changed with fine granularity according to the bit rate.

However, because the bit rate of the OTUCn frame is 100 Gbps×n, even when the PS technique is used, a bit rate that is an integer multiple of 100 Gbps like 100 Gbps, 200 Gbps, or 400 Gbps, for example, is desired to be selected. For this reason, there is a problem that the selection of the bit rate of the multi-level modulation involves limitation based on the bit rate of the OTUCn frame and it is difficult to set the bit rate with fine granularity.

In view of the above, it is desirable to provide optical transmission system and apparatus and a transmission method that may set the bit rate with fine granularity.

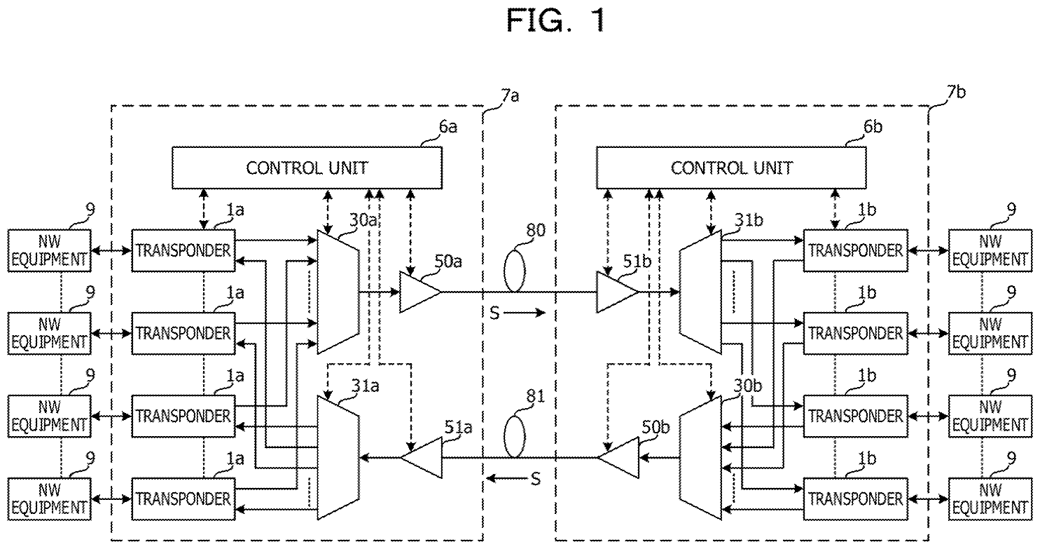

FIG. 1 is a configuration diagram illustrating one example of an optical transmission system. The optical transmission system includes one set of wavelength multiplexing optical transmission apparatuses 7a and 7b coupled through transmission paths 80 and 81 such as optical fibers. The wavelength multiplexing optical transmission apparatuses 7a and 7b transmit and receive a wavelength-multiplexed optical signal S into which plural optical signals different in the wavelength are wavelength-multiplexed to and from each other.

The wavelength multiplexing optical transmission apparatus 7a includes plural transponders 1a, an optical multiplexing unit 30a, an optical demultiplexing unit 31a, optical amplifiers 50a and 51a, and a control unit 6a. Furthermore, the wavelength multiplexing optical transmission apparatus 7b includes plural transponders 1b, an optical multiplexing unit 30b, an optical demultiplexing unit 31b, optical amplifiers 50b and 51b, and a control unit 6b.

The transponders 1a and 1b transmit and receive optical signals. The optical signals have the format of the OTUCn frame prescribed in ITU-T Recommendation G.709 as one example. The transponders 1a and 1b are one example of a first optical transmission apparatus and a second optical transmission apparatus.

The transponders 1a and 1b are coupled to pieces of network (NW) equipment 9 such as routers on the client network side. The transponders 1a and 1b transmit and receive plural client signals with the pieces of network equipment 9. The transponders 1a and 1b cause the plural client signals from the pieces of network equipment 9 to be accommodated in a common frame to output the frame to the optical multiplexing units 30a and 30b, and extract plural client signals from a frame from the optical multiplexing units 30a and 30b to transmit the client signals to the piece of network equipment 9. The client signal is one example of a data signal.

The optical multiplexing units 30a and 30b are optical selection switches or optical filters, for example, and carry out wavelength multiplexing of the optical signals input from the plural transponders 1a and 1b into wavelength-multiplexed optical signals to output them to the optical amplifiers 50a and Sob. The optical amplifiers 50a and 50b amplify the wavelength-multiplexed optical signals and output them to the transmission paths 80 and 81.

The wavelength-multiplexed optical signals are input from the transmission paths 81 and 80 to the optical amplifiers 51a and 51b. The optical amplifiers 51a and 51b amplify the wavelength-multiplexed optical signals and output them to the optical demultiplexing units 31a and 31b.

The optical demultiplexing units 31a and 31b are optical selection switches or optical filters, for example, and demultiplex the wavelength-multiplexed optical signals into optical signals of each wavelength. The optical signals are input from the optical demultiplexing units 31a and 31b to the plural transponders 1a and 1b.

The control units 6a and 6b are circuits including a processor such as a central processing unit (CPU), and control the wavelength multiplexing optical transmission apparatuses 7a and 7b. The control units 6a and 6b set the gain for the optical amplifiers 50a and 50b and set the frame of the wavelength multiplexing target for the optical multiplexing units 30a and 30b, for example. Furthermore, the control units 6a and 6b set the optical signals of the demultiplexing target for the optical demultiplexing units 31a and 31b and carry out setting relating to accommodation of client signals in a frame for the transponders 1a and 1b, for example.

### First Embodiment

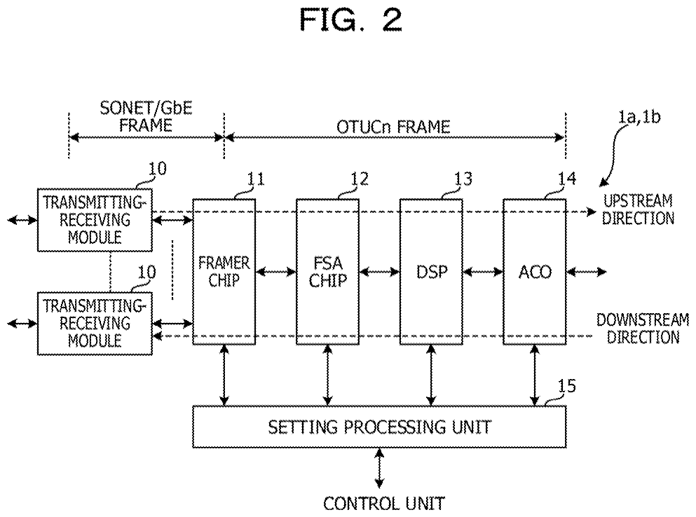

FIG. 2 is a configuration diagram illustrating one example of a transponder of a first embodiment. The transponder depicted in FIG. 2 may be the transponder 1a or 1b depicted in FIG. 1. The transponders 1a and 1b include plural transmitting-receiving modules 10, a framer chip 11, an FSA chip 12, a digital signal processor (DSP) 13, analog coherent optics (ACO) 14, and a setting processing unit 15. The framer chip 11 and the FSA chip 12 are packages, for example, circuit chips, independent of each other.

The transmitting-receiving modules 10 are optical modules that can be attached and detached to and from a circuit board on which the framer chip 11 is mounted with the intermediary of an electrical connector, for example. The transmitting-receiving modules 10 transmit and receive client signals with the network equipment 9. As the frame format of the client signal, for example, the Synchronous Optical Network (SONET) frame and the GbE (GigabitEthernet (registered trademark)) frame are cited. However, the frame format is not limited thereto.

Processing of the upstream direction from the transmitting-receiving modules 10 toward the ACO 14 will be described.

The transmitting-receiving modules 10 carry out optical-electrical conversion of the client signals received from the network equipment 9 and output them to the framer chip 11. The framer chip 11 causes the client signals input from the respective transmitting-receiving modules 10 to be accommodated in an OTUCn frame. Although the OTUCn frame is cited as one example of the frame in the present example, the frame is not limited to the OTUCn frame and another frame format may be used.

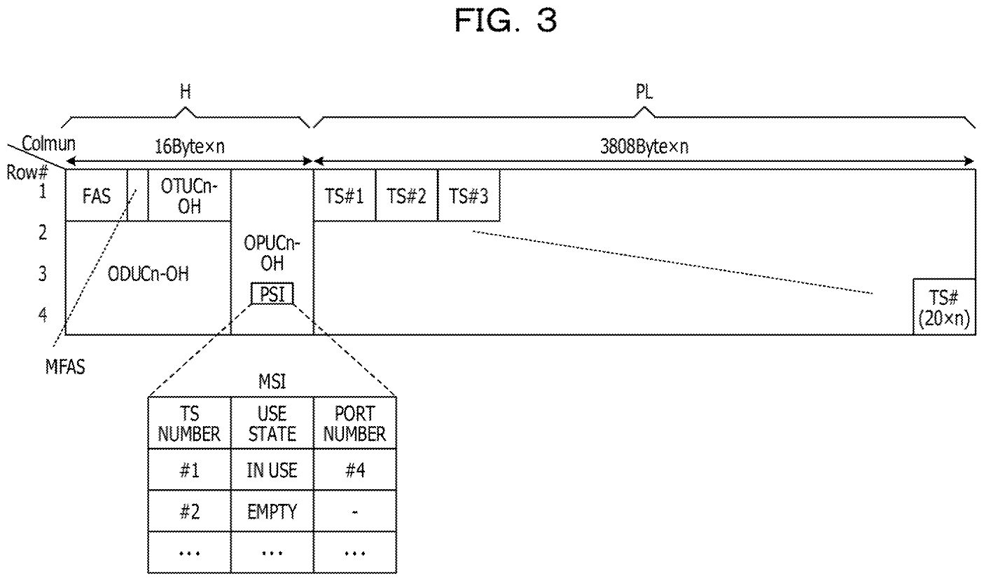

FIG. 3 is a diagram illustrating one example of an OTUCn frame. The OTUCn frame includes a header part H and a payload part PL.

The header part H includes frame alignment signal (FAS), multiframe alignment signal (MFAS), OTUCn-overhead (OH), ODUCn (ODU: Optical Data Unit)-OH, and OPUCn (OPU: Optical Payload Unit)-OH. The FAS and the MFAS are alignment patterns of the OTUCn frame. Furthermore, various kinds of control information are included in the OTUCn-OH, the ODUCn-OH, and the OPUCn-OH.

Plural tributary slots (TSs) #1 to #(20×n) (n: positive integer) are included in the payload part PL. Data of a client signal is accommodated in each TS. Among the TSs are used TSs in which data is accommodated and empty TSs in which data is not accommodated. The TS is one example of the slot and the empty TS is one example of the empty slot.

The size of the OTUCn frame changes according to the positive integer n. The size of the header part H is 16 Byte×n (Column)×4 (Row) and the size of the payload part PL is 3808 Byte×n (Column)×4 (Row).

In the OPUCn-OH, the payload structure identifier (PSI) that represents the configuration of the payload part PL is included. In the PSI, the multiplex structure identifier (MSI) that is information relating to TS #1 to #(20× n) is included. In the MSI, the respective pieces of information of TS number (#1, #2, . . . ), use state, and port number are included.

The use state represents which of “in use” and “empty” the state of the TS indicated by the TS number is. The use state of the used TS is “in use” and the use state of the empty TS is “empty.” The port number indicates the port of the reception source or transmission destination of the client signal accommodated in the TS indicated by the TS number (for example, number of the transmitting-receiving module 10). For example, the client signal of port #4 is accommodated in TS #1 and the client signal is not accommodated in TS #2.

The bit rate of the OTUCn frame is 100 Gbps×n according to the positive integer n. In the payload part PL, 20 TSs are stored in every size corresponding to 100 Gbps. Thus, the size of one TS is equivalent to the bit rate of 5 Gbps (=100/20).

Referring to FIG. 2 again, the framer chip 11 outputs the OTUCn frame to the FSA chip 12. The FSA chip 12 reduces the size of the OTUCn frame and outputs the OTUCn frame to the DSP 13 at a bit rate according to the size after the reduction.

The DSP 13 modulates the OTUCn frame by a multi-level modulation system and outputs the OTUCn frame to the ACO 14. The ACO 14 converts the OTUCn frame from the electrical signal to an optical signal and outputs the OTUCn frame to the optical multiplexing unit 30a or 30b.

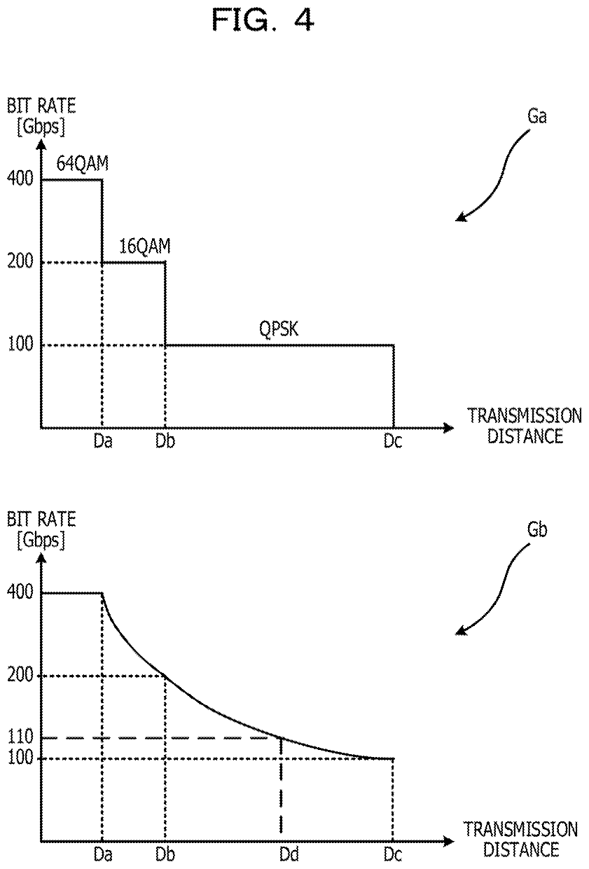

FIG. 4 is a diagram illustrating change in a bit rate with respect to a transmission distance in a comparative example and the embodiment. Here, the transmission distance is the distance across which transmission can be carried out with a bit error rate equal to or lower than a reference value, for example.

Symbol Ga represents change in the bit rate of the DSP 13 in the comparative example. As the multi-level modulation system of the DSP 13, QPSK, 16 QAM, and 64 QAM can be selected, for example.

When the multi-level degree of the multi-level modulation system is higher, the number of bits that can be mapped on one symbol becomes larger and therefore the bit rate becomes higher. The respective bit rates of QPSK, 16 QAM, and 64 QAM are 100 Gbps, 200 Gbps, and 400 Gbps, respectively.

However, when the multi-level degree of the multi-level modulation system is higher, the transmission distance becomes shorter. For example, the transmission distance of 64 QAM is 0 to Da and the transmission distance of 16 QAM is Da to Db and the transmission distance of QPSK is Db to Dc. Here, a relationship of Da<Db<Dc holds.

Thus, for example, if the transmission distance of 16 QAM is not permitted when the bit rate of the OTUCn frame is 200 Gbps (n=2), it is possible to extend the transmission distance by using QPSK, which has a lower multi-level degree than 16 QAM. However, in this case, the bit rate decreases to 100 Gbps, which is half the bit rate in the case of 16 QAM.

Symbol Gb represents change in the bit rate of the DSP 13 in the embodiment. The DSP 13 may change the bit rate of the multi-level modulation with fine granularity by the PS technique. Thus, the transmission distance may also be changed with fine granularity according to the bit rate. For example, if the requested transmission distance is Dd (Db<Dd<Dc), transmission at a bit rate of 110 Gbps according to the transmission distance Dd is enabled.

This PS technique is a technique in which the probability of mapping on symbols (signal points) near the center in the constellation is controlled by encoding data of the modulation target before mapping of the data on symbols. By the control of the probability of mapping on symbols, the number of bits and the error rate of the data turned to symbols change. Therefore, it becomes possible to change the bit rate and the transmission distance with fine granularity.

However, because the bit rate of the OTUCn frame is 100 Gbps×n, even when the PS technique is used, a bit rate that is an integer multiple of 100 Gbps like 100 Gbps, 200 Gbps, or 400 Gbps, for example, is desired to be selected.

For this reason, the FSA chip 12 adjusts the size of the OTUCn frame and outputs the OTUCn frame to the DSP 13 at a bit rate according to the size after the reduction. Accordingly, the bit rate of the OTUCn frame does not have to be set to an integer multiple of 100 Gbps and it becomes possible to set the bit rate with fine granularity.

Referring to FIG. 2 again, processing of the downstream direction from the ACO 14 toward the transmitting-receiving modules 10 will be described.

The ACO 14 converts an optical signal to an electrical signal and outputs the electrical signal to the DSP 13. The DSP 13 executes demodulation processing of the electrical signal to reproduce an OTUCn frame and output it to the FSA chip 12. The FSA chip 12 returns the size of the OTUCn frame to the size before reduction and outputs the OTUCn frame to the framer chip 11.

The framer chip 11 extracts client signals from used TSs of the OTUCn frame and output them to the transmitting-receiving modules 10. The transmitting-receiving modules 10 convert the client signals from electrical signals to optical signals and transmit the client signals to the network equipment 9.

Furthermore, the setting processing unit 15 carries out various kinds of setting for the framer chip 11, the FSA chip 12, the DSP 13, and the ACO 14 in accordance with an instruction of the control unit 6a or 6b. For example, a user inputs the use status of each port of the transponders 1a and 1b on the client network side to the control units 6a and 6b. The control units 6a and 6b transfer the use status of each port on the client network side to the setting processing unit 15. The setting processing unit 15 sets the framer chip 11, the FSA chip 12, the DSP 13, and the ACO 14 according to the use status of each port.

(Frame Processing of Upstream Direction)

Next, functions of a transponder in an upstream direction will be described.

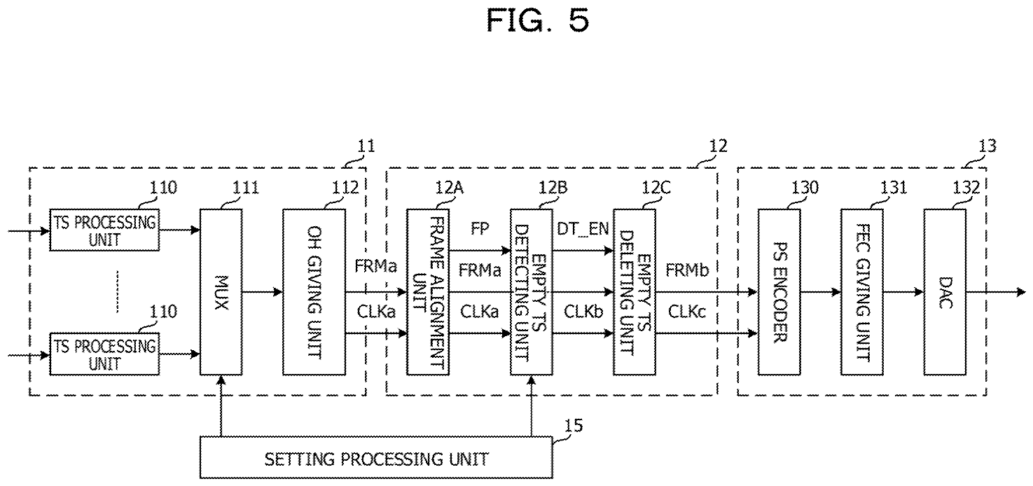

FIG. 5 is a configuration diagram illustrating one example of functions of a transponder in an upstream direction. The transponder depicted in FIG. 5 may be the transponder 1a or 1b depicted in FIG. 1. In FIG. 5, the configuration of the framer chip 11, the FSA chip 12, and the DSP 13 is illustrated.

The framer chip 11 includes plural TS processing units 110, a multiplexing unit (MUX) 111, and an overhead (OH) giving unit 112. The TS processing units 110 carry out mapping of client signals from the transmitting-receiving modules 10 on a low-order ODU and output the low-order ODU to the multiplexing unit 111.

The multiplexing unit 111 causes the low-order ODU to be accommodated in TSs in the payload part PL of an OTUCn frame. The MSI (see FIG. 3) is set in the multiplexing unit 111 from the setting processing unit 15 in advance. The multiplexing unit 111 generates the payload part PL by causing the low-order ODU to be accommodated in TSs in accordance with the MSI and outputs the payload part PL to the OH giving unit 112.

The OH giving unit 112 generates the OTUCn frame by generating the header part H and giving it to the payload part PL. At this time, the OH giving unit 112 acquires the MSI from the multiplexing unit 111 and stores it in the OPUCn-OH. The OH giving unit 112 outputs a frame signal FRMa of the OTUCn frame and a clock signal CLKa that synchronizes with the frame signal FRMa to the FSA chip 12. The plural TS processing units 110, the multiplexing unit 111, and the OH giving unit 112 are one example of the generating unit that generates the OTUCn frame.

The FSA chip 12 includes a frame alignment unit 12A, an empty TS detecting unit 128, and an empty TS deleting unit 12C. The frame alignment unit 12A establishes alignment with the OTUCn frame by detecting the FAS and the MFAS of the OTUCn frame input from the OH giving unit 112. The frame alignment unit 12A outputs a frame pulse FP and the clock signal CLKa of the OTUCn frame to the empty TS detecting unit 12B. Furthermore, the frame alignment unit 12A outputs the frame signal FRMa including the OTUCn frame to the empty TS deleting unit 12C.

The empty TS detecting unit 12B is one example of the first detecting unit and detects one or more empty TSs in which the client signal is not accommodated in plural TSs in the OTUCn frame. The MSI is set in the empty TS detecting unit 12B from the setting processing unit 15. The empty TS detecting unit 126 detects the beginning of the OTUCn frame by the frame pulse FP and detects the positions of the empty TSs from the MSI by using the beginning as the basis.

The empty TS detecting unit 12B generates an enable signal DT_EN that represents the positions of the empty TSs in the OTUCn frame based on the detection result of the empty TSs. The enable signal DT_EN is one example of the first position signal that represents the position of the empty slot. The empty TS detecting unit 126 outputs the enable signal DT_EN to the empty TS deleting unit 12C.

Furthermore, the empty TS detecting unit 126 generates a clock signal CLKb by deleting pulses according to the time width of the empty TSs in the OTUCn frame from the clock signal CLKa. The clock signal CLKb is a partially-intermittent clock signal. The empty TS detecting unit 12B outputs the clock signal CLKb to the empty TS deleting unit 12C. The clock signal CLKa is one example of the first clock signal and the clock signal CLKb is one example of the second clock signal.

The empty TS deleting unit 12C is one example of the frame processing unit and reduces the size of the OTUCn frame by deleting the empty TSs from the OTUCn frame based on the enable signal DT_EN and closing up the gaps between the remaining used TSs. Furthermore, the empty TS deleting unit 12C generates a dock signal CLKc with a frequency according to the size of the OTUCn frame after the reduction from the dock signal CLKb. The clock signal CLKc is one example of the third dock signal. The empty TS deleting unit 12C outputs the clock signal CLKc and a frame signal FRMb of the OTUCn frame with the reduced size to the DSP 13.

The DSP 13 includes a PS encoder 130, a forward error correction (FEC) giving unit 131, and a digital-to-analog converter (DAC) 132. The PS encoder 130 receives the frame signal FRMb and the clock signal CLKc from the empty TS deleting unit 12C.

The PS encoder 130 carries out mufti-level modulation by encoding the frame signal FRMb and mapping it on symbols by the PS technique, for example. The PS encoder 130 executes modulation processing based on the clock signal CLKc. Thus, the bit rate of the OTUCn frame after the modulation becomes the bit rate according to the frequency of the clock signal CLKc. The PS encoder 130 outputs the modulated frame signal FRMb to the FEC giving unit 131.

The FEC giving unit 131 gives an FEC code to the frame signal FRMb. The FEC code is one example of an error correction code of the frame signal FRMb. However, the error correction code is not limited to the FEC code and another code may be used. The FEC giving unit 131 outputs the frame signal FRMb given the FEC code to the DAC 132. The DAC 132 converts the frame signal FRMb from the digital signal to an analog signal and outputs the frame signal FRMb to the ACO 14.

As above, the DSP 13 changes the bit rate of the multi-level modulation by the PS technique, for example. For example, the PS technique is one of coding modulation techniques and is a technique that allows transmission of entropy (information amount) desired to be transmitted with lower power by changing the weight (probability) of each point according to the coordinates regarding the IQ constellation of the multi-level modulation as described above. Furthermore, the PS technique is a technique that can lower the symbol error rate by causing the probability distribution of the IQ constellation to have a characteristic, for example. The DSP 13 is one example of the optical modulation processing unit.

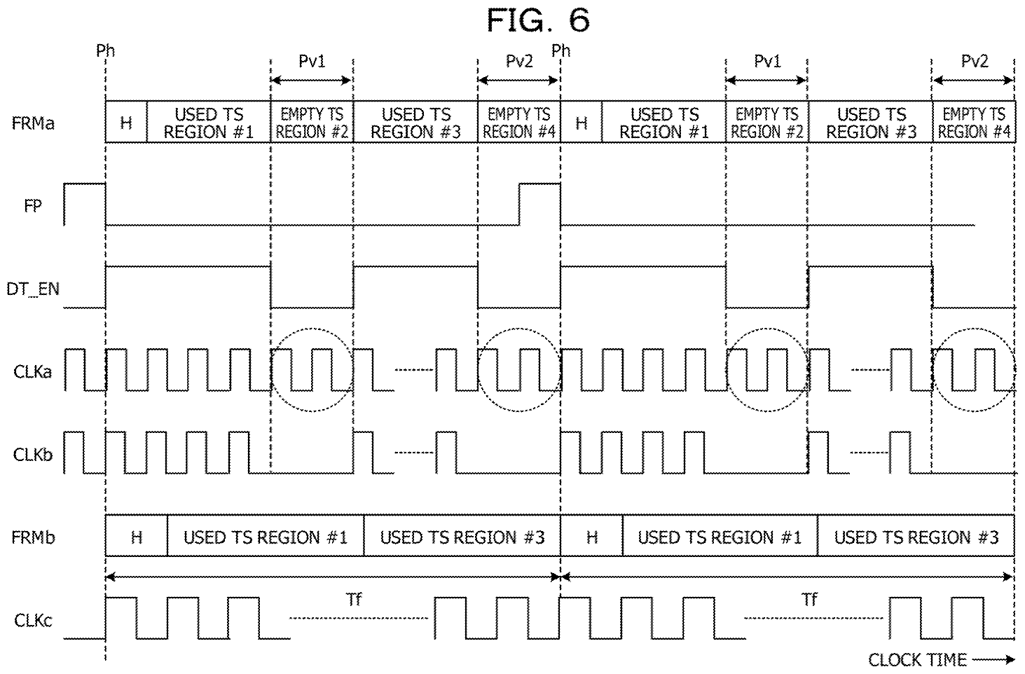

FIG. 6 is a time chart illustrating one example of the frame signals FRMa and FRMb, the clock signals CLKa, CLKb, and CLKc, the frame pulse FP, and the enable signal. DT_EN. In the OTUCn frame, the header part H and TS regions #1 to #4 are included. Suppose that TS region #1 and TS region #3 each include plural used TSs (hereinafter, represented as “used TS region”) and TS region #2 and TS region #4 each include plural empty TSs (hereinafter, represented as “empty TS region”).

The empty TS detecting unit 128 detects a position Ph of the header part H, for example, the beginning of the OTUCn frame, on the time axis based on the frame pulse FR The empty TS detecting unit 128 detects a position Pv1 of empty TS region #2 on the time axis and a position Pv2 of empty TS region #4 on the time axis based on the position Ph of the beginning and the MSI.

The empty TS detecting unit 128 generates the enable signal DT_EN′ from the positions Pv1 and Pv2 of empty TS regions #2 and #4. The logical value of the enable signal DT_EN is “0” at the positions Pv1 and Pv2 of empty TS regions #2 and #4 and is “1” at the other positions.

Furthermore, the empty TS detecting unit 128 generates the partially-intermittent clock signal CLKb by deleting pulses (see dotted-line circles) corresponding to the positions Pv1 and Pv2 of empty TS regions #2 and #4 from the clock signal CLKa that synchronizes with the frame signal FRMa.

The empty TS deleting unit 12C generates the clock signal CLKc from the partially-intermittent clock signal CLKb by a phase locked loop (PLL) circuit. The clock signal CLKc has the same number of pulses as the partially-intermittent clock signal CLKb in a given time. For example, the clock signal CLKc is what is obtained by averaging the position and time width of the pulses of the partially-intermittent clock signal CLKb in terms of time. For this reason, the frequency of the clock signal CLKc is lower than the frequency of the clock signal CLKb.

The empty TS deleting unit 12C outputs the OTUCn frame as the frame signal FRMb by causing the frame signal FRMa from which empty TS regions #2 and #4 have been removed to synchronize with the clock signal CLKc. Thus, in the frame signal FRMb, the size of the OTUCn frame is reduced by the size corresponding to empty TS regions #2 and #4 compared with the frame signal FRMa. However, the time width Tf of the OTUCn frame of the frame signals FRMa and FRMb is the same.

The empty TS deleting unit 12C outputs the frame signal FRMb to the PS encoder 130 in accordance with the dock signal CLKc. The PS encoder 130 carries out multi-level modulation of the frame signal FRMb in accordance with the clock signal CLKc. For example, the PS encoder 130 carries out the multi-level modulation of the OTUCn frame with the reduced size at the bit rate according to the size after the reduction.

For this reason, even when the framer chip 11 outputs the OTUCn frame at a bit rate of 100 Gbps×n, the FSA chip 12 reduces the size of the OTUCn frame by the size corresponding to the empty TSs and thereby the multi-level modulation at the bit rate according to the size after the reduction is enabled. Thus, the transponders 1a and 1b may transmit the OTUCn frame not at an integer multiple of 100 Gbps but with granularity of 5 Gbps, which is the bit rate equivalent to the size of the TS. This makes it possible to set also the transmission distance with fine granularity according to the data amount of the client signal accommodated in the payload part PL of the OTUCn frame.

Next, a configuration of an FSA chip relating to processing of an OTUCn frame in an upstream direction will be described.

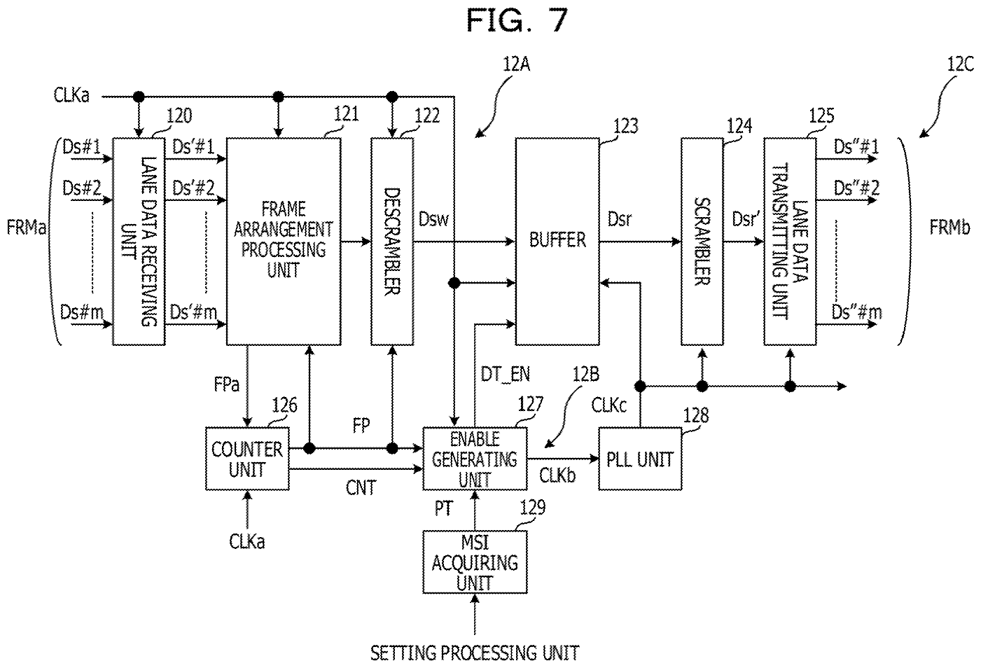

FIG. 7 is a configuration diagram illustrating one example of a configuration of an FSA chip relating to processing of an OTUCn frame in an upstream direction. The FSA chip depicted in FIG. 7 may be the FSA chip 12 depicted in FIG. 2. The FSA chip 12 is a circuit including hardware such as a field programmable gate array (FPGA) or application specified integrated circuit (ASIC). The FSA chip 12 includes a lane data receiving unit 120, a frame arrangement processing unit 121, a descrambler 122, a buffer 123, a scrambler 124, a lane data transmitting unit 125, a counter unit 126, an enable generating unit 127, a PLL unit 128, and an MSI acquiring unit 129.

The lane data receiving unit 120, the frame arrangement processing unit 121, the descrambler 122, and the counter unit 126 are included in the frame alignment unit 12A. The enable generating unit 127 and the MSI acquiring unit 129 are included in the empty TS detecting unit 128. The buffer 123, the scrambler 124, the lane data transmitting unit 125, and the PLL unit 128 are included in the empty TS deleting unit 12C.

The frame alignment unit 12A operates in accordance with the clock signal CLKa from the framer chip 11. The lane data receiving unit 120 receives, from the framer chip 11, pieces of lane data Ds #1 to # m obtained by parallel conversion of the frame signal FRMa to m (positive integer) pieces of data. The lane data receiving unit 120 recognizes the OTUCn frame from the pieces of lane data Ds #1 to # m and reproduces the OTUCn frame by executing rearrangement among the lanes and deskew processing. The lane data receiving unit 120 outputs pieces of lane data Ds′ #1 to # m of the reproduced OTUCn frame to the frame arrangement processing unit 121.

The frame arrangement processing unit 121 outputs a frame pulse FPa that represents the position of the beginning of the OTUCn frame to the counter unit 126 by detecting the FAS and the MFAS of the OTUCn frame. The counter unit 126 generates a counter value CNT of the OTUCn frame from the frame pulse FPa and the clock signal CLKa and outputs the counter value CNT to the enable generating unit 127.

Furthermore, the counter unit 126 generates the frame pulse FP by correcting the timing of the frame pulse FPa according to the timing of the counter value CNT and outputs the frame pulse FP to the enable generating unit 127, the frame arrangement processing unit 121 and the descrambler 122. This establishes alignment of the OTUCn frame.

The frame arrangement processing unit 121 outputs the data of the OTUCn frame to the descrambler 122 in accordance with the frame pulse FP and the clock signal CLKa. The descrambler 122 descrambles the data of the OTUCn frame and outputs the OTUCn frame to the buffer 123 as writing data Dsw. The clock signal CLKa is input to the buffer 123 and the writing data Dsw is written to the buffer 123 in synchronization with the clock signal CLKa.

The MSI acquiring unit 129 acquires the MSI from the setting processing unit 15. The MSI acquiring unit 129 generates position information PT of the empty TS based on the MSI and outputs the position information PT to the enable generating unit 127.

The enable generating unit 127 detects the positions of the empty TSs based on the position information PT, the frame pulse. FP, and the counter value CNT and generates the enable signal DT_EN based on the result of the detection to output it to the buffer 123, Furthermore, the enable generating unit 127 generates the partially-intermittent clock signal CLKb from the clock signal CLKa based on the position information PT, the frame pulse FP, and the counter value CNT and outputs the clock signal CLKb to the PLL unit 128.

The buffer 123 is one example of the first storing unit and stores the OTUCn frame from which the empty TSs have been removed based on the enable signal DT_EN. The buffer 123 is a first-in first-out (FIFO) buffer and outputs the data of the OTUCn frame in order of input.

The buffer 123 stores the writing data Dsw if the logical value of the enable signal DT_EN is “1” and does not store the writing data Dsw if the logical value of the enable signal DT_EN is “0.” The empty TSs correspond to the positions of the logical value “0” of the enable signal DT_EN and therefore are not written to the buffer 123.

Furthermore, the scrambler 124 is one example of the first readout unit and reads out the OTUCn frame stored in the buffer 123 in accordance with the data clock signal CLKc. The OTUCn frame in the buffer 123 is input to the scrambler 124 as read-out data Dsr. Because the empty TS is not included in the read-out data Dsr, the used TSs are packed in the payload part PL of the OTUCn frame in the read-out data Dsr.

As above, the OTUCn frame from which the empty TSs have been removed in accordance with the enable signal DT_EN is stored in the buffer 123. Thus, the storing volume of the buffer 123 is reduced compared with the case in which the whole of the OTUCn frame is stored. Differently from the present example, the whole of the OTUCn frame may be stored in the buffer 123 and the scrambler 124 may read out the OTUCn frame with removal of the empty TSs.

The PLL unit 128 includes a PLL circuit. The PLL unit 128 is one example of the phase synchronization unit and executes phase synchronization processing of the clock signal CLKc based on the phase difference between the partially-intermittent clock signal CLKb and the clock signal CLKc. This allows the FSA chip 12 to generate the clock signal CLKc according to the size of the OTUCn frame after the reduction with high accuracy.

The scrambler 124 executes scramble processing of the read-out data Dsr in accordance with the clock signal CLKc and outputs the resulting data to the lane data transmitting unit 125 as transmission data Dsr′. The lane data transmitting unit 125 divides the transmission data Dsr′ for each of lanes #1 to # m and outputs the resulting data to the DSP 13 as pieces of lane data Ds″#1 to # m. The pieces of lane data Ds″#1 to # m are output to the DSP 13 in synchronization with the clock signal CLKc. The pieces of lane data Ds″#1 to # m correspond to the frame signal FRMb.

Next, a flow of processing of an OTUCn frame in an upstream direction by an FSA chip will be described.

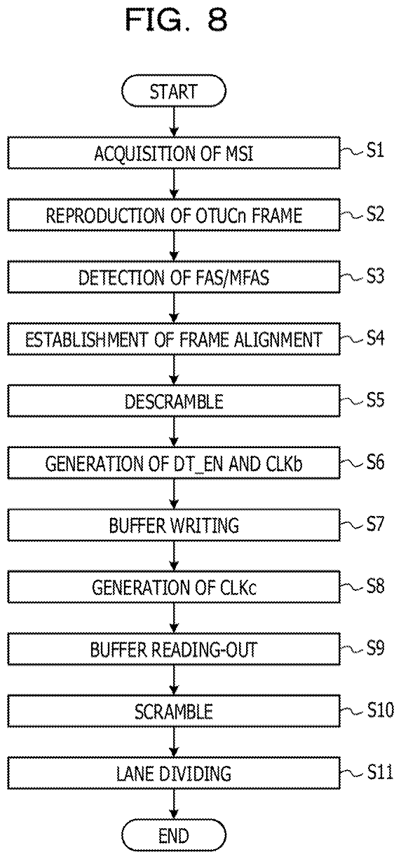

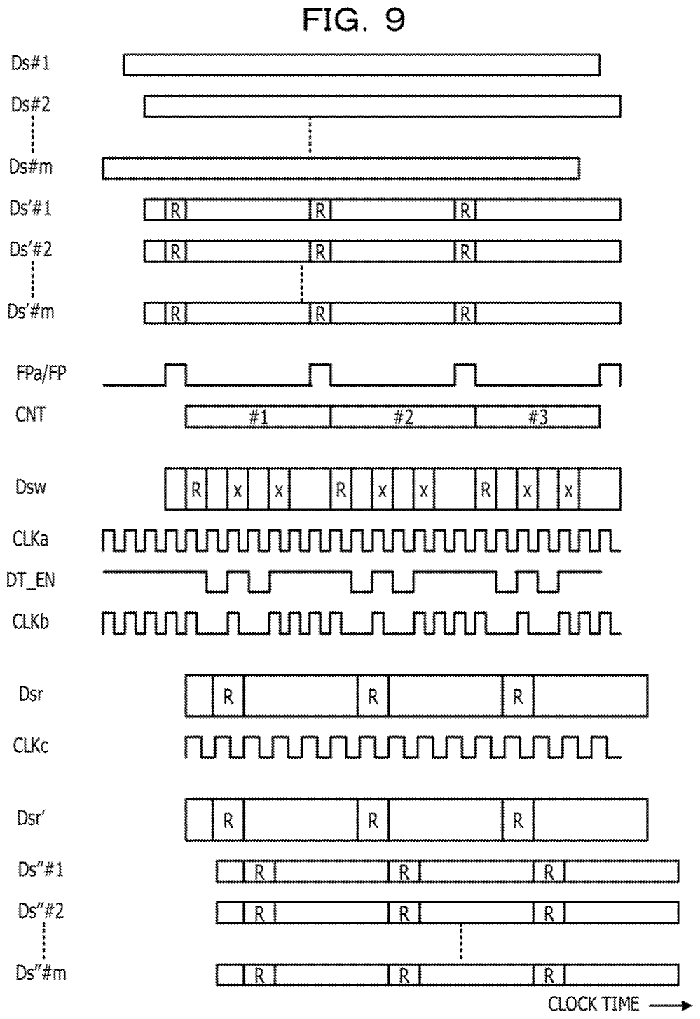

FIG. 8 is a flowchart illustrating one example of processing of an OTUCn frame in an upstream direction by an FSA chip. FIG. 9 is a time chart illustrating the one example of the processing of the OTUCn frame in the upstream direction by the FSA chip. The FSA chip described with reference to FIGS. 8 and 9 may be the FSA chip 12 depicted in FIG. 2.

First, the MSI acquiring unit 129 acquires the MSI from the setting processing unit 15 (step SU). The MSI is input to the enable generating unit 127 as the position information PT. Thereby, the enable generating unit 127 detects the empty TSs of the OTUCn frame.

Next, the lane data receiving unit 120 reproduces the OTUCn frame from pieces of lane data Ds #1 to # m (step St2). The lane data receiving unit 120 executes rearrangement of the pieces of lane data Ds #1 to # m and deskew processing. The lane data receiving unit 120 detects alignment pattern data R of each of the pieces of lane data Ds #1 to # m, for example, and aligns the phase to output the resulting data as pieces of lane data Ds′#1 to # m.

Next, the frame arrangement processing unit 121 detects the FAS and the MFAS of the OTUCn frame from the pieces of lane data Ds′#1 to # m (step St3), Thereby, the frame arrangement processing unit 121 generates the frame pulse FPa and outputs it to the counter unit 126. Furthermore, the frame arrangement processing unit 121 converts the pieces of lane data Ds′#1 to # m to one frame signal and outputs the frame signal to the descrambler 122.

Next, the counter unit 126 establishes frame alignment by counting the counter value CNT based on the frame pulse FPa (step SM). The counter unit 126 adjusts the timing of the frame pulse FPa to generate the frame pulse FP. In FIG. 9, the frame pulse FPa and the frame pulse FP are depicted as a common signal for convenience.

Next, the descrambler 122 executes descramble processing of the OTUCn frame (step St5). There is no limit to the system of the descramble processing.

Next, the enable generating unit 127 generates the enable signal DT_EN and the clock signal CLKb based on the position information PT, the frame pulse FP, and the counter value CNT (step St6). The enable signal DT_EN is input to the buffer 123 and the dock signal CLKb is input to the PLL unit 128.

Next, the descrambler 122 writes the OTUCn frame to the buffer 123 as the writing data Dsw (step St7). The descrambler 122 writes the writing data Dsw in synchronization with the clock signal CLKa. The buffer 123 stores the writing data Dsw only during the period in which the logical value of the enable signal DT_EN is “1.” Thus, the empty TSs (see symbols x) in the writing data Dsw are not stored in the buffer 123. For example, writing of the empty TS is skipped in accordance with the enable signal DT_EN.

Next, the PLL unit 128 generates the clock signal CLKc for reading out from the buffer 123 from the partially-intermittent clock signal CLKb (step St8). The clock signal CLKb is what is obtained by removing the pulses of the periods of the empty TSs from the clock signal CLKa for writing of the OTUCn frame. Thus, the frequency of the dock signal CLKc is lower than the frequency of the original clock signal CLKa by a frequency corresponding to the number of removed pulses.

Next, the scrambler 124 reads out the OTUCn frame from the buffer 123 as the read-out data Dsr in synchronization with the clock signal CLKc (step St9). Because the empty TS is not written to the buffer 123, the empty TS is not included in the read-out data Dsr. Furthermore, the read-out data Dsr is read out in synchronization with the clock signal CLKc and therefore the time width of the OTUCn frame is the same in the read-out data Dsr and the writing data Dsw.

As above, the size of the OTUCn frame is reduced through deletion of the empty TSs, whereas the time width of the OTUCn frame is kept. This allows the transponder 1a or 1b on the receiving side to normally restore the OTUCn frame with the original size.

Next, the scrambler 124 executes scramble processing of the OTUCn frame (step St10). The OTUCn frame for which the scramble processing has been executed is input to the lane data transmitting unit 125 as the transmission data Dsr′. There is no limit to the system of the scramble processing.

Next, the lane data transmitting unit 125 divides the transmission data Dsr′ for each of the lanes #1 to # m (step St11). Pieces of lane data Ds″#1 to # m after the dividing are output to the DSP 13 in synchronization with the clock signal CLKc. In this manner, the processing of the OTUCn frame in the upstream direction is executed.

(Frame Processing in Downstream Direction)

Next, functions of a transponder in a downstream direction will be described.

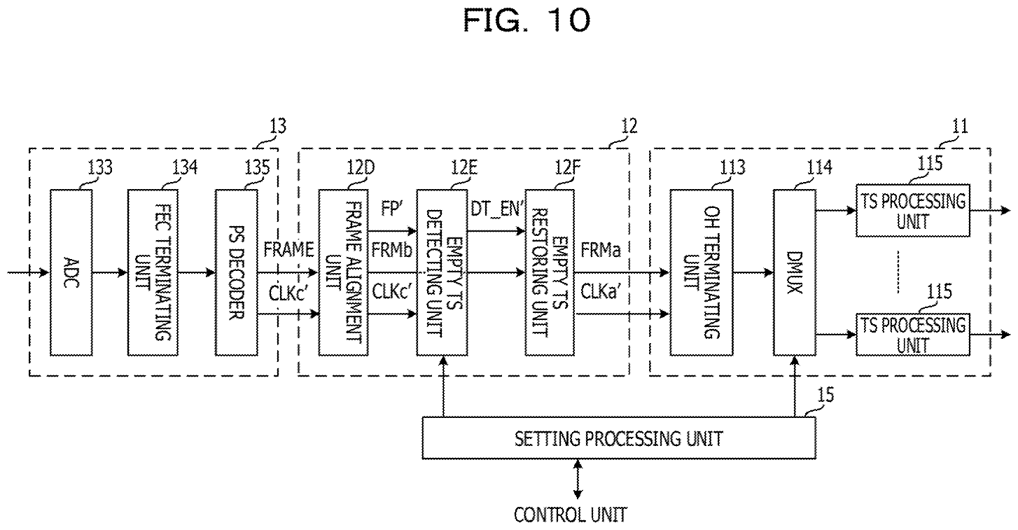

FIG. 10 is a configuration diagram illustrating one example of functions of a transponder in a downstream direction. The transponder depicted in FIG. 10 may be the transponder 1a or 1b depicted in FIG. 1. In FIG. 10, the configuration of the framer chip 11, the FSA chip 12, and the DSP 13 is illustrated.

The DSP 13 includes an analog-to-digital converter (ADC) 133, an FEC terminating unit 134, and a PS decoder 135. The ADC 133 converts an optical signal input from the ACO 14 to an electrical signal and outputs the electrical signal to the FEC terminating unit 134. The FEC terminating unit 134 terminates an FEC code given to the OTUCn frame. The OTUCn frame is output from the FEC terminating unit 134 to the PS decoder 135.

The PS decoder 135 decodes the OTUCn frame encoded by the PS encoder 130 to execute demodulation processing. The PS decoder 135 outputs the OTUCn frame to the FSA chip 12 in synchronization with a clock signal CLKc′. The clock signal CLKc′ is what is extracted from the optical signal received in the ACO 14.

The FSA chip 12 includes a frame alignment unit 12D, an empty TS detecting unit 12E, and an empty TS restoring unit 12F. The frame alignment unit 12D establishes synchronization with the OTUCn frame by detecting the FAS and the MFAS of the OTUCn frame input from the PS decoder 135. The frame alignment unit 12D outputs a frame pulse FP′ of the OTUCn frame and the clock signal CLKc′ to the empty TS detecting unit 12E. Furthermore, the frame alignment unit 12D outputs the frame signal FRMb including the OTUCn frame to the empty TS restoring unit 12F.

The empty TS detecting unit 12E is one example of the second detecting unit and detects the positions from which the empty TSs have been deleted in the OTUCn frame. The MSI is set in the empty TS detecting unit 12E from the setting processing unit 15. The empty TS detecting unit 12E detects the beginning of the OTUCn frame by the frame pulse FP′ and detects the positions of the empty TSs from the MSI by using the beginning as the basis.

The empty TS detecting unit 12E generates an enable signal DT_EN′ that represents the positions from which the empty TSs have been deleted in the OTUCn frame based on the detection result of the empty TSs. The enable signal DT_EN′ is one example of the second position signal that represents the position from which the empty slot has been deleted. The empty TS detecting unit 12E outputs the enable signal DT_EN′ to the empty TS restoring unit 12F.

The empty TS restoring unit 12F is one example of the restoration processing unit and, based on the detection result of the positions from which the empty TSs have been deleted, inserts empty TSs at these positions in the OTUCn frame to return the size of the OTUCn frame to the size before the deletion of the empty TSs. Furthermore, the empty TS restoring unit 12F generates a clock signal Ma′ with a frequency according to the size of the OTUCn frame before the reduction from the clock signal CLKc′. The empty TS restoring unit 12F outputs the clock signal CLKa′ and the frame signal FRMa of the OTUCn frame whose size has been returned to the original size to the framer chip 11.

The framer chip 11 includes an OH terminating unit 113, a demultiplexing unit (DMUX) 114, and plural TS processing units 115. The OH terminating unit 113 terminates the header part H of the OTUCn frame. The OH terminating unit 113 outputs the left payload part PL to the demultiplexing unit 114.

The demultiplexing unit 114 demultiplexes used TSs from the payload part PL based on the MSI acquired from the setting processing unit 15. The demultiplexing unit 114 outputs the used TSs to the TS processing units 115. The TS processing unit 115 is one example of the extracting unit and extracts a client signal from the used TS of the OTUCn frame whose size has been returned by the empty TS restoring unit 12F. The TS processing unit 115 outputs the client signal to the transmitting-receiving module 10.

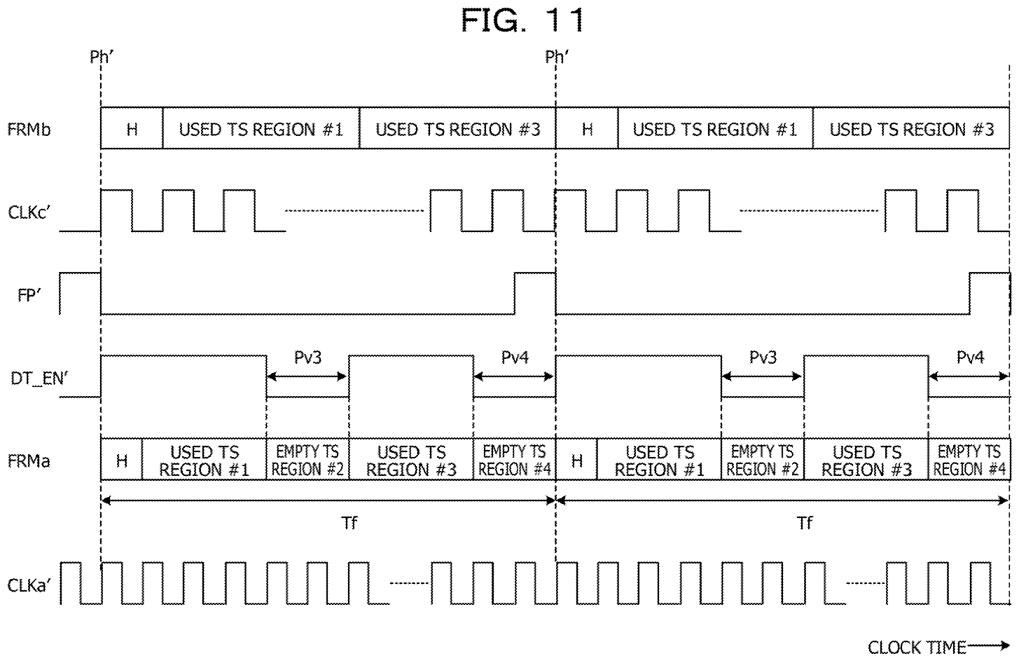

FIG. 11 is a time chart illustrating one example of the frame signals FRMa and FRMb, the clock signals CLKa′ and CLKc′, the frame pulse FP′, and the enable signal DT_EN′. The present example corresponds to the example illustrated in FIG. 6 and the clock signals CLKa′ and Mc′ have the same frequency as the clock signals CLKa and CLKc, respectively, in the upstream direction in the transponder 1a or 1b on the transmitting side.

The empty TS detecting unit 12E detects a position Ph′ of the header part H, for example, the beginning of an OTUCn frame, on the time axis based on the frame pulse FP′. Based on the position Ph′ of the beginning and the MSI, the empty TS detecting unit 12E detects positions Pv3 and Pv4, on the time axis, of empty TS region #2 and empty TS region #4 deleted by the empty TS deleting unit 12C of the transponder 1a or 1b on the transmitting side.

The empty TS detecting unit 12E generates the enable signal DT_EN″ from the positions Pv3 and Pv4 of empty TS regions #2 and #4. The logical value of the enable signal DT_EN″ is “0” at the positions Pv3 and Pv4 of empty TS regions #2 and #4 and is “1” at the other positions.

The empty TS restoring unit 12F inserts empty TSs at the positions represented by the enable signal DT_EN′ for the OTUCn frame. Thereby, empty TS regions #2 and #4 are inserted in the frame signal FRMa.

The empty TS restoring unit 12F generates the clock signal CLKc′ from the clock signal CLKa′ by a PLL circuit. The clock signal CLKa′ is a transmission dock extracted from the optical signal input from the transmission path 80 or 81 and corresponds to the size of the OTUCn frame after the reduction. Furthermore, the dock signal CLKc′ corresponds to the size of the OTUCn frame before the reduction, for example, after the restoration. For example, the empty TS restoring unit 12F generates the dock signal CLKc′ by dividing the frequency of the clock signal CLKa′ based on the MSI acquired from the setting processing unit 15.

The empty TS restoring unit 12F outputs the frame signal FRMa after the insertion of empty TS regions #2 and #4 in synchronization with the clock signal CLKc′, Thus, in the frame signal FRMa, the size of the OTUCn frame is larger than the frame signal FRMb by the size of empty TS regions #2 and #4. However, the time width Tf of the OTUCn frame of the frame signals FRMa and FRMb is the same.

Next, a configuration of an FSA chip relating to processing of an OTUCn frame in a downstream direction will be described.

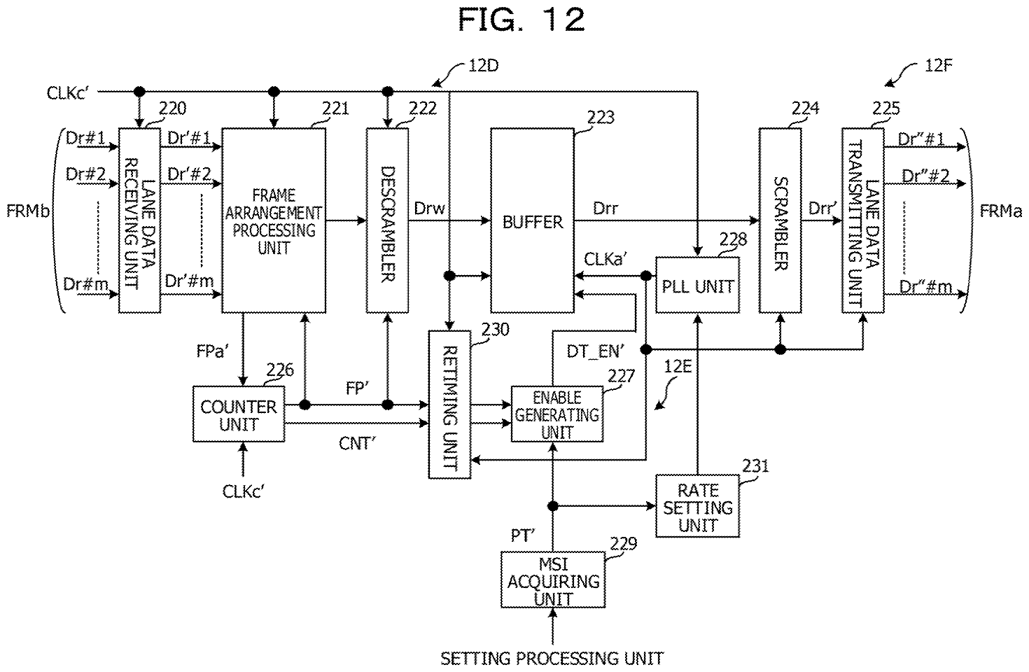

FIG. 12 is a configuration diagram illustrating one example of a configuration of an FSA chip relating to processing of an OTUCn frame in a downstream direction. The FSA chip depicted in FIG. 12 may be the FSA chip 12 depicted in FIG. 2. The FSA chip 12 includes a lane data receiving unit 220, a frame arrangement processing unit 221, a descrambler 222, a buffer 223, a scrambler 224, a lane data transmitting unit 225, a counter unit 226, and an enable generating unit 227. Moreover, the FSA chip 12 includes a PLL unit 228, an MSI acquiring unit 229, a retiming unit 230, and a rate setting unit 231.

The lane data receiving unit 220, the frame arrangement processing unit 221, the descrambler 222, the counter unit 226, and the retiming unit 230 are included in the frame alignment unit 12D. The enable generating unit 227 and the MSI acquiring unit 229 are included in the empty TS detecting unit 12E. The buffer 223, the scrambler 224, the lane data transmitting unit 225, the PLL unit 228, and the rate setting unit 231 are included in the empty TS restoring unit 12F.

The frame alignment unit 12D operates in accordance with the clock signal CLKc′ from the DSP 13. The lane data receiving unit 220 receives, from the DSP 13, pieces of lane data Dr #1 to # m obtained by parallel conversion of the frame signal FRMb to m pieces of data. The lane data receiving unit 220 recognizes the OTUCn frame from the pieces of lane data Dr #1 to # m and reproduces the OTUCn frame after reduction in the size by executing rearrangement among the lanes and deskew processing. The lane data receiving unit 220 outputs pieces of lane data Dr #1 to # m of the reproduced OTUCn frame to the frame arrangement processing unit 221.

The frame arrangement processing unit 221 outputs a frame pulse FPa′ that represents the position of the beginning of the OTUCn frame to the counter unit 226 by detecting the FAS and the MFAS of the OTUCn frame. The counter unit 226 generates a counter value CNT′ of the OTUCn frame from the frame pulse FPa′ and the clock signal CLKc′ and outputs the counter value CNT′ to the enable generating unit 227.

Furthermore, the counter unit 226 generates the frame pulse FP′ by correcting the timing of the frame pulse FPa′ according to the timing of the counter value CNT′ and outputs the frame pulse FP′ to the enable generating unit 227, the frame arrangement processing unit 221, and the descrambler 222. This establishes alignment of the OTUCn frame.

The frame arrangement processing unit 221 outputs the data of the OTUCn frame to the descrambler 222 in accordance with the frame pulse FP′ and the dock signal CLKc′. The descrambler 222 descrambles the data of the OTUCn frame and outputs the OTUCn frame to the buffer 223 as writing data Drw. The clock signal CLKc′ is input to the buffer 223 and the writing data Drw is written to the buffer 223 in synchronization with the dock signal CLKc′.

The retiming unit 230 carries out retiming of the frame pulse FP′ and the counter value CNT′ that synchronize with the clock signal CLKc′ in such a manner that the frame pulse FP′ and the counter value CNT′ synchronize with the clock signal CLKa′, and output the frame pulse FP′ and the counter value CNT′ to the enable generating unit 227. The clock signal CLKa′ is input from the PLL unit 228 to the retiming unit 230.

The MSI acquiring unit 229 acquires the MSI from the setting processing unit 15. The MSI acquiring unit 229 generates position information PT′ of the empty TS based on the MSI and outputs the position information PT′ to the enable generating unit 227 and the rate setting unit 231.

The enable generating unit 227 detects the deletion positions of the empty TSs from the position information PT′, the frame pulse FP′, and the counter value CNT′ and generates the enable signal DT_EN′ based on the result of the detection to output it to the buffer 223. For example, the rate setting unit 231 calculates the ratio of the size of the OTUCn frame after the reduction to the size before the reduction from the position information PT′ and sets the frequency of the clock signal CLKa′ in the PLL unit 228 according to the ratio of the sizes.

The PLL unit 228 includes a PLL circuit. The PLL unit 228 executes phase synchronization processing of the clock signal CLKa′ based on the phase difference between the clock signal CLKa′ and the clock signal CLKc′. At this time, the frequency of the clock signal CLKa′ is decided in accordance with the rate set from the rate setting unit 231. The PLL unit 228 outputs the clock signal CLKa′ to the retiming unit 230, the buffer 223, the scrambler 224, and the lane data transmitting unit 225.

The buffer 223 is one example of the second storing unit and stores the OTUCn frame received from the transponder 1a or 1b on the transmitting side. The buffer 223 is a FIFO buffer and outputs the data of the OTUCn frame in order of input.

The scrambler 224 is one example of the second readout unit and reads out the OTUCn frame from the buffer 223 as read-out data Drr in synchronization with the clock signal CLKc′. In contrast, in readout of the OTUCn frame, the buffer 223 outputs empty data to the scrambler 224 at the positions represented by the enable signal DT_EN′.

For example, the buffer 223 outputs the read-out data Drr if the logical value of the enable signal DT_EN′ is “1” and outputs empty data without outputting the read-out data Drr if the logical value of the enable signal DT_EN′ is “0.” This empty data corresponds to the empty TS in the OTUCn frame. Thereby, the empty TSs are inserted in the OTUCn frame.

As above, the buffer 223 inserts the empty TSs in the OTUCn frame by outputting empty data to the scrambler 224 in accordance with the enable signal DT_EN′. Thus, the buffer 223 does not need to ensure the region for storing the empty TSs and therefore the storing volume of the buffer 223 is reduced.

The scrambler 224 executes scramble processing of the read-out data Drr in accordance with the clock signal CLKa′ and outputs the resulting data to the lane data transmitting unit 225 as transmission data Drr′. The lane data transmitting unit 225 divides the transmission data Drr′ for each of lanes #1 to # m and outputs the resulting data to the framer chip 11 as pieces of lane data Dr″ #1 to # m. The pieces of lane data Dr #1 to # m are output to the framer chip 11 in synchronization with the clock signal CLKa′. The pieces of lane data Dr″ #1 to # m correspond to the frame signal FRMa.

Next, a flow of processing of an OTUCn frame in a downstream direction by an FSA chip will be described.

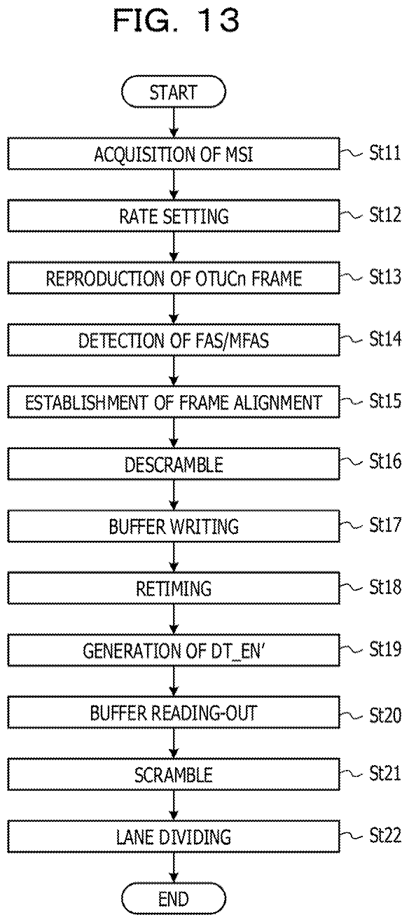

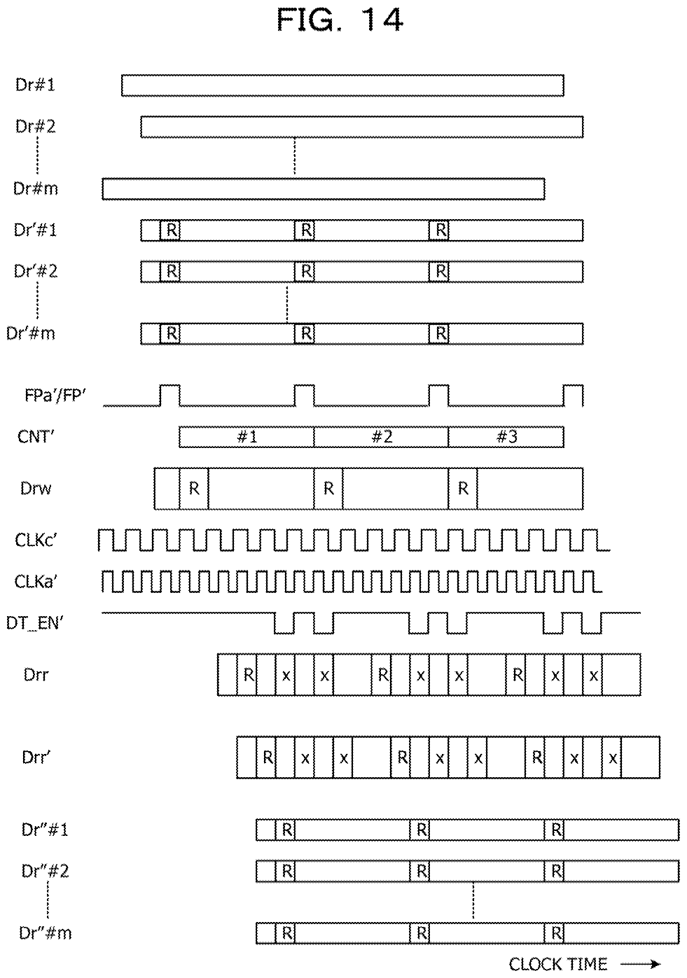

FIG. 13 is a flowchart illustrating one example of processing of an OTUCn frame in a downstream direction by an FSA chip. FIG. 14 is a time chart illustrating the one example of the processing of the OTUCn frame in the downstream direction by the FSA chip. The FSA chip described with reference to FIGS. 13 and 14 may be the FSA chip 12 depicted in FIG. 2.

First, the MSI acquiring unit 229 acquires the MSI from the setting processing unit 15 (step St11). The MSI is input to the enable generating unit 227 and the rate setting unit 231 as the position information PT′. Thereby, the enable generating unit 227 detects the positions from which empty TSs have been deleted in the OTUCn frame.

Next, the rate setting unit 231 calculates the ratio of the respective sizes of the OTUCn frame before and after reduction based on the position information PT′ and sets the frequency of the dock signal. CLKa′ in the PLL unit 228 according to the ratio of the sizes (step St12).

Next, the lane data receiving unit 220 reproduces the OTUCn frame after the reduction in the size from the pieces of lane data Dr #1 to # m (step St13). The lane data receiving unit 220 executes rearrangement of the pieces of lane data Dr #1 to # m and deskew processing. The lane data receiving unit 220 detects the alignment pattern data R of each of the pieces of lane data Dr #1 to # m, for example, and aligns the phase to output the resulting data as pieces of lane data Dr #1 to # m.

Next, the frame arrangement processing unit 221 detects the FAS and the MFAS of the OTUCn frame from the pieces of lane data DC #1 to # m (step St14), Thereby, the frame arrangement processing unit 221 generates the frame pulse FPa′ and outputs it to the counter unit 226. Furthermore, the frame arrangement processing unit 221 converts the pieces of lane data Dr′#1 to # m to one frame signal and outputs the frame signal to the descrambler 222.

Next, the counter unit 226 establishes frame alignment by counting the counter value CNT′ based on the frame pulse FPa′ (step St15), The counter unit 226 adjusts the timing of the frame pulse FPa′ to generate the frame pulse FP′. In FIG. 14, the frame pulse FPa′ and the frame pulse FP′ are depicted as a common signal for convenience.

Next, the descrambler 222 executes descramble processing of the OTUCn frame (step St16). There is no limit to the system of the descramble processing.

Next, the descrambler 222 writes the OTUCn frame to the buffer 223 as the writing data Drw (step St17). The descrambler 222 writes the writing data Drw in synchronization with the clock signal CLKc′.

Next, the retiming unit 230 carries out retiming of the frame pulse FP′ and the counter value CNT″ in such a manner that the frame pulse FP′ and the counter value CNT′ synchronize with the clock signal CLKa′ (step St18), Thereby, the frame pulse FP′ and the counter value CNT′ are reloaded on the clock signal CLKa′ from the clock signal CLKc′.

Next, the enable generating unit 227 generates the enable signal DT_EN′ based on the position information Pr, the frame pulse FP′, and the counter value CNT (step St19). The enable signal DT_EN′ is input to the buffer 223.

Next, the scrambler 224 reads out the OTUCn frame from the buffer 223 as the read-out data Drr in synchronization with the clock signal CLKa′ (step St20). The buffer 223 outputs pieces of empty data (see symbols x) in the periods in which the logical value of the enable signal DT_EN′ represents “0.” Thereby, the empty TSs are inserted in the OTUCn frame and therefore the size of the OTUCn frame is restored to the size before the reduction. Furthermore, the read-out data Drr is read out in synchronization with the clock signal CLKa′ and therefore the time width of the OTUCn frame is the same in the read-out data Drr and the writing data Drw.

Next, the scrambler 224 executes scramble processing of the OTUCn frame (step St21). The OTUCn frame for which the scramble processing has been executed is input to the lane data transmitting unit 225 as the transmission data Drr′. There is no limit to the system of the scramble processing.

Next, the lane data transmitting unit 225 divides the transmission data Drr′ for each of the lanes #1 to # m (step St22). Pieces of lane data Dr″#1 to # m after the dividing are output to the framer chip 11 in synchronization with the clock signal CLKa′. In this manner, the processing of the OTUCn frame in the downstream direction is executed.

### Second Embodiment

The transponders 1a and 1b of the first embodiment may have functions of the FSA chip 12 while using the existing framer chip 11 because the FSA chip 12 is disposed between the framer chip 11 and the DSP 13. However, if the framer chip 11 is caused to have the functions of the FSA chip 12, the size of the transponders 1a and 1b may be reduced through making the mounting space of the FSA chip 12 unnecessary.

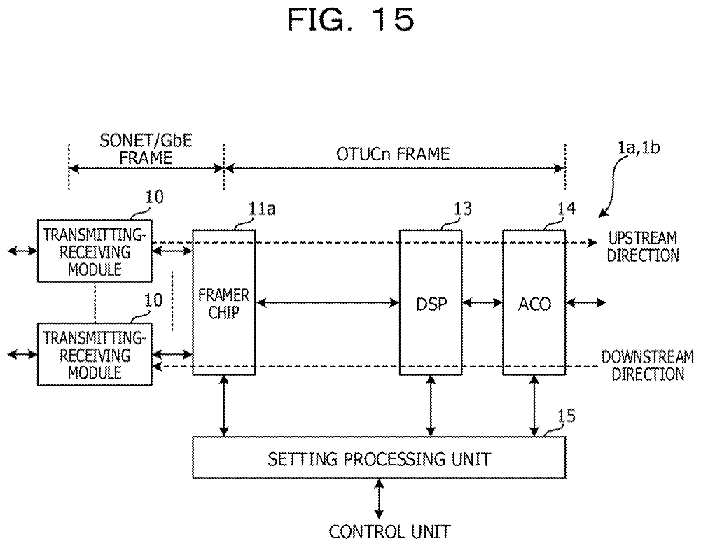

FIG. 15 is a configuration diagram illustrating one example of the transponders 1a and 1b of the second embodiment. In FIG. 15, the configuration common with FIG. 2 is given the same symbol and description thereof is omitted.

A framer chip 11a is set instead of the framer chip 11 in the first embodiment. The framer chip 11a is a circuit chip obtained by adding functions of the FSA chip 12 to functions of the framer chip 11.

(Frame Processing in Upstream Direction)

Next, a configuration of a framer chip relating to processing of an OTUCn frame in an upstream direction will be described.

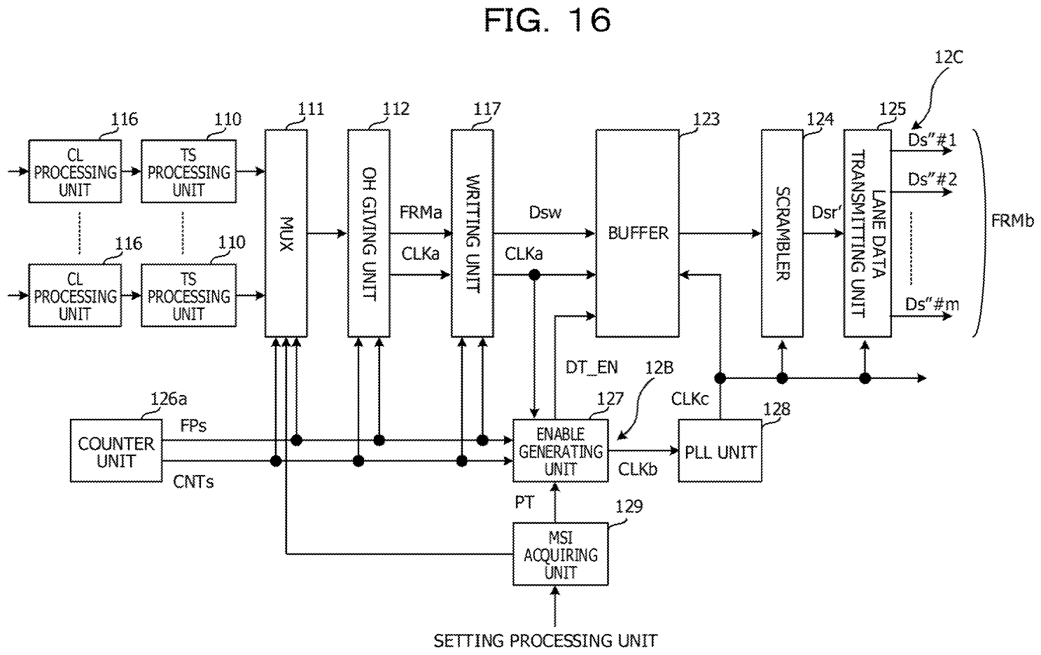

FIG. 16 is a configuration diagram illustrating one example of a configuration of a framer chip relating to processing of an OTUCn frame in an upstream direction. The framer chip depicted in FIG. 16 may be the framer chip 11a depicted in FIG. 15. In FIG. 16, the configuration common with FIG. 5 and FIG. 7 is given the same symbol and description thereof is omitted. The framer chip 11a is a circuit including hardware such as an FPGA or ASIC.

The framer chip 11a includes the TS processing units 110, the multiplexing unit 111, the OH giving unit 112, client (CL) processing units 116, a writing unit 117, the buffer 123, the scrambler 124, the lane data transmitting unit 125, a counter unit 126a, the enable generating unit 127, the PLL unit 128, and the MSI acquiring unit 129. The framer chip 11a controls the processing timing of the OTUCn frame by the counter unit 126a and therefore the frame alignment unit 12A is not set therein.

The CL processing units 116 execute monitoring processing, overhead processing, and so forth for client signals input from the transmitting-receiving modules 10 according to the kind of the client signals (for example, SONET frame or GbE frame). The CL processing units 116 output the client signals to the TS processing units 110.

The counter unit 126a is set instead of the counter unit 126. The counter unit 126a generates a frame pulse FPs and a counter value CNTs from a free-run dock signal, for example, and outputs them to the multiplexing unit 111, the OH giving unit 112, and the enable generating unit 127, The multiplexing unit 111 and the OH giving unit 112 generate an OTUCn frame from the client signals based on the frame pulse FPs and the counter value CNTs. The multiplexing unit 111 multiplexes TSs in accordance with the MSI input from the MSI acquiring unit 129.

The OH giving unit 112 generates the OTUCn frame and outputs it to the writing unit 117 as the frame signal FRMa. The OH giving unit 112 generates the clock signal CLKa that synchronizes with the frame signal FRMa and outputs the clock signal CLKa to the writing unit 117.

The writing unit 117 writes the frame signal FRMa to the buffer 123 as the writing data Dsw. The writing unit 117 writes the writing data Dsw in synchronization with the clock signal CLKa.

The enable generating unit 127 generates the enable signal DT_EN and the partially-intermittent clock signal CLKb based on the position information PT, the frame pulse FPs, and the counter value CNTs. The OTUCn frame excluding empty TSs is written to the buffer 123 in accordance with the enable signal DT_EN.

Next, a flow of processing of an OTUCn frame in an upstream direction by a framer chip will be described.

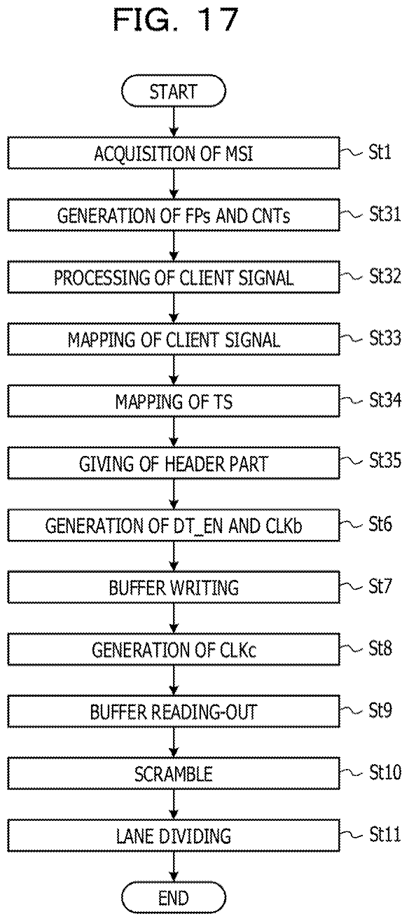

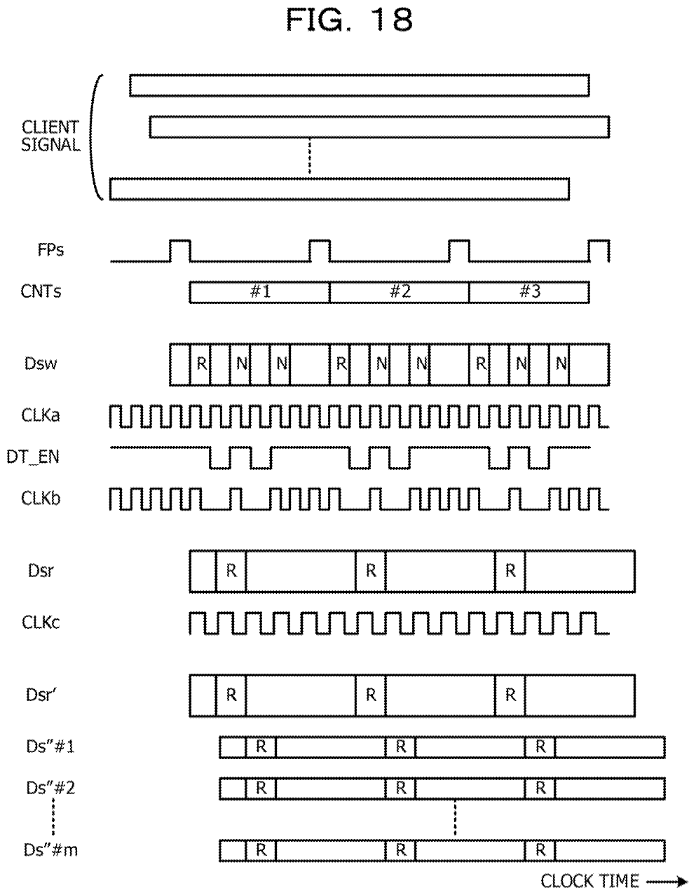

FIG. 17 is a flowchart illustrating one example of processing of an OTUCn frame in an upstream direction by a framer chip. Furthermore, FIG. 18 is a time chart illustrating the one example of the processing of the OTUCn frame in the upstream direction by the framer chip. The framer chip described with reference to FIGS. 17 and 18 may be the framer chip 11a depicted in FIG. 15. In FIG. 17, processing common with FIG. 8 is given the same symbol and description thereof is omitted.

After the processing of the step St1, the counter unit 126a generates the frame pulse FPs and the counter value CNTs (step St31). Next, the CL processing units 116 carry out monitoring processing, overhead processing, and so forth of client signals (step St32). Next, the TS processing units 110 carry out mapping of the client signals on TSs (step St33). Thereby, the client signals are accommodated in the TSs.

Next, the multiplexing unit 111 carries out mapping of the TSs on the payload part PL based on the MSI (step St34). Thereby, the TSs are accommodated in the payload part PL. The multiplexing unit 111 causes, for example, fixed pattern data to be accommodated in the TS regarding which the use state is “empty” in the MSI.

Next, the OH giving unit 112 gives the header part H to the payload part PL input from the multiplexing unit 111 (step St35). Thereby, the OTUCn frame is generated from the client signals. In this manner, the processing of the OTUCn frame in the upstream direction is executed.

(Frame Processing in Downstream Direction)

Next, a configuration of a framer chip relating to processing of an OTUCn frame in a downstream direction will be described.

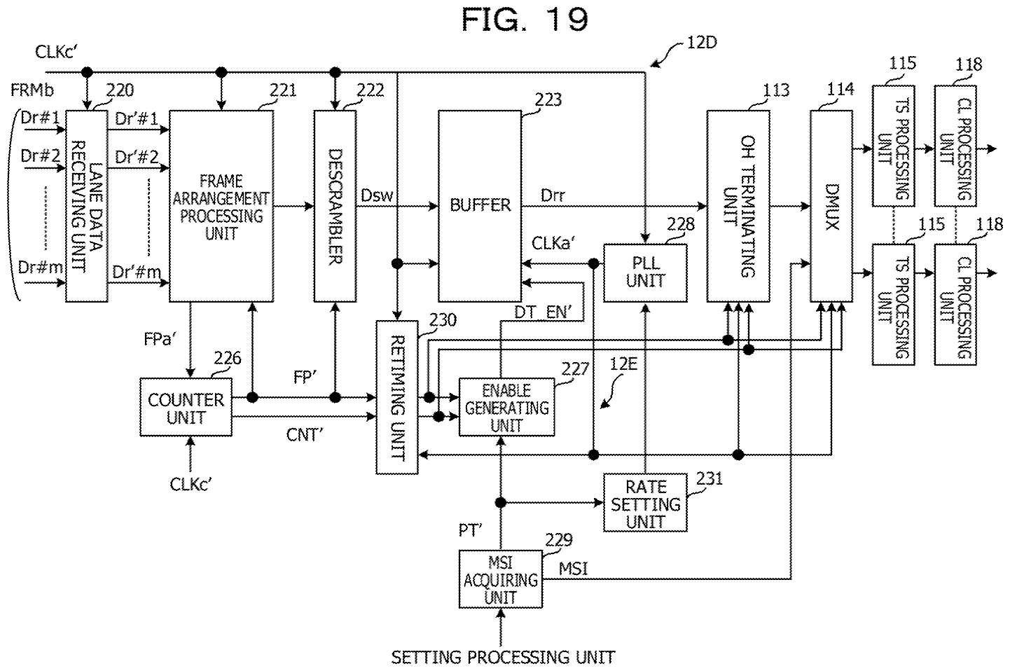

FIG. 19 is a configuration diagram illustrating one example of a configuration of a framer chip relating to processing of an OTUCn frame in a downstream direction. The framer chip depicted in FIG. 19 may be the framer chip 11a depicted in FIG. 15. In FIG. 19, the configuration common with FIG. 10 and FIG. 12 is given the same symbol and description thereof is omitted.

The framer chip 11a includes the lane data receiving unit 220, the frame arrangement processing unit 221, the descrambler 222, the buffer 223, the counter unit 226, the enable generating unit 227, the PLL unit 228, the MSI acquiring unit 229, the retiming unit 230, and the rate setting unit 231. Moreover, the framer chip 11a includes the OH terminating unit 113, the demultiplexing unit 114, the plural TS processing units 115, and the plural CL processing units 118.

The frame pulse FP′, the counter value CNT′, and the clock signal CLKa′ are input to the OH terminating unit 113 and the demultiplexing unit 114. The OH terminating unit 113 is one example of the second readout unit and reads out the read-out data Drr from the buffer 223. The buffer 223 outputs pieces of empty data to the OH terminating unit 113 in the periods in which the logical value of the enable signal DT_EN′ represents “0.” Thereby, empty TSs are inserted in the OTUCn frame and therefore the size of the OTUCn frame returns to the size before the reduction.

The MSI is input from the MSI acquiring unit 129 to the demultiplexing unit 114, The demultiplexing unit 114 demultiplexes TSs from the payload part PL in accordance with the MSI and outputs the TSs to the TS processing units 115 corresponding to the TSs. The TS processing units 115 extract client signals from the TSs and output the client signals to the CL processing units 118.

The CL processing units 118 execute monitoring processing, overhead processing, and so forth for the client signals according to the kind of the client signals (for example, SONET frame or GbE frame). The CL processing units 118 output the client signals to the transmitting-receiving modules 10.

Next, a flow of processing of an OTUCn frame in a downstream direction by a framer chip will be described.

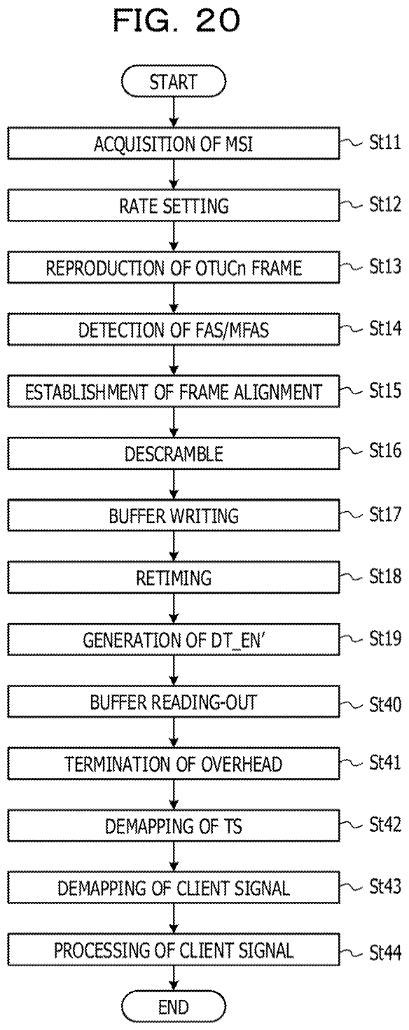

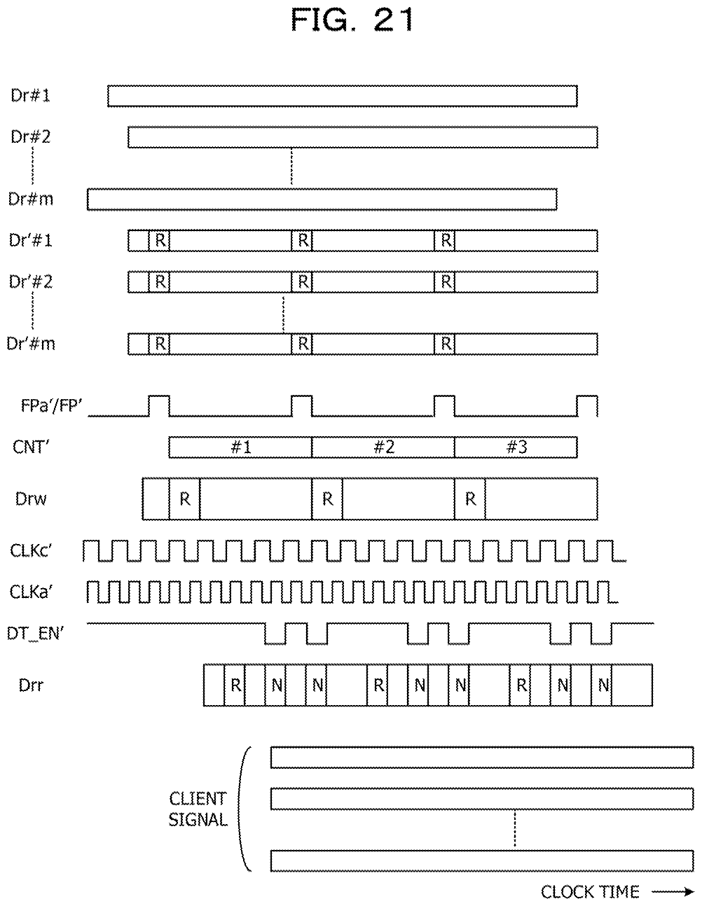

FIG. 20 is a flowchart illustrating one example of processing of an OTUCn frame in a downstream direction by a framer chip. Furthermore, FIG. 21 is a time chart illustrating the one example of the processing of the OTUCn frame in the downstream direction by the framer chip. The framer chip described with reference to FIGS. 20 and 21 may be the framer chip 11a depicted in FIG. 15. In FIG. 20, processing common with FIG. 13 is given the same symbol and description thereof is omitted.

After the processing of the step St19, the OH terminating unit 113 reads out the read-out data Drr from the buffer 223 (step St40). Next, the OH terminating unit 113 detects the header part H of the OTUCn frame from the read-out data Drr and terminates the header part H based on the frame pulse FP′, the counter value CNT′, and the clock signal CLKa′ (step St41). The OH terminating unit 113 outputs the payload part PL of the OTUCn frame to the demultiplexing unit 114.

The demultiplexing unit 114 carries out demapping of TSs from the payload part PL in accordance with the MSI (step St42). Thereby, each TS is demultiplexed from the payload part PL. The demultiplexing unit 114 outputs the TSs to the TS processing units 115 according to the port number of the MSI. The demultiplexing unit 114 does not have to demultiplex the TS regarding which the use state is “empty” in the MSI from the payload part PL.

The TS processing units 115 carry out demapping of client signals from the TSs (step St43). Thereby, the client signals are extracted from the TSs. The TS processing units 115 output the client signals to the CL processing units 118.

Next, the CL processing units 118 execute monitoring processing, overhead processing, and so forth of the client signals (step St44). The client signals are output to the transmitting-receiving modules 10. In this manner, the processing of the OTUCn frame in the downstream direction is executed.

In the present embodiment, the empty TS detecting unit 12B and the empty TS deleting unit 12C are set on a circuit chip common to the multiplexing unit 111, the OH giving unit 112, and the TS processing units 110, for example, on a common package, differently from the first embodiment. Furthermore, the empty TS detecting unit 12E and the empty TS restoring unit 12F are set on a circuit chip common to the OH terminating unit 113, the demultiplexing unit 114, and the TS processing units 115, for example, on a common package, differently from the first embodiment.

For this reason, according to the present embodiment, the size of the transponders 1a and 1b may be made smaller than the first embodiment through making the mounting space of the FSA chip 12 unnecessary.

In the first embodiment, functions of the frame processing in the upstream direction by the FSA chip 12 illustrated in FIG. 7 and functions of the frame processing in the downstream direction by the FSA chip 12 illustrated in FIG. 12 may be mounted on circuit chips independent of each other, and furthermore may be mounted on a transmitting-side transponder and a receiving-side transponder, respectively, independent of each other. Also in this case, the mounting space of the FSA chip 12 may be made unnecessary by using the framer chip 11a having the functions of at least one of the frame processing in the upstream direction and the frame processing in the downstream direction.

The above-described embodiments are examples of preferred embodiments of the present disclosure. However, techniques of the present disclosure are not limited thereto and can be carried out with various modifications without departing from the gist of the present disclosure.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A transmission system comprising:
a first optical transmission apparatus configured to transmit a frame including a plurality of slots that each accommodate a data signal; and
a second optical transmission apparatus configured to receive the frame, wherein
the first optical transmission apparatus includes
a first detecting circuit that detects one or more empty slots in which the data signal is not accommodated in the plurality of slots,
a frame processing circuit that reduces size of the frame by deleting the one or more empty slots from the frame based on a detection result of the one or more empty slots and closing up gaps between remaining slots in the plurality of slots, and
an optical modulation processing circuit that carries out multi-level modulation of the frame at a bit rate according to size of the frame after reduction, and
the second optical transmission apparatus includes
a second detecting circuit that detects positions from which the one or more empty slots have been deleted in the frame, and
a restoration processing circuit that returns the size of the frame to size before deletion of the one or more empty slots by inserting the one or more empty slots at the positions from which the one or more empty slots have been deleted in the frame based on a detection result of the positions.

2. The transmission system according to claim 1, wherein
the optical modulation processing circuit carries out multi-level modulation of the frame by probabilistic shaping.

3. The transmission system according to claim 1, wherein
the first detecting circuit generates a first position signal that represents positions of the one or more empty slots in the frame based on the detection result of the one or more empty slots, and
the frame processing circuit includes
a first storing unit that stores the frame from which the one or more empty slots have been removed based on the first position signal, and
a first readout circuit that reads out the frame from the first storing unit.

4. The transmission system according to claim 3, wherein
the first detecting circuit deletes pulses according to time width of the one or more empty slots in the frame from a first clock signal that synchronizes with the frame input to the first storing unit to generate a second clock signal,
the first readout circuit reads out the frame from the first storing unit in accordance with a third clock signal, and
the frame processing circuit includes a phase synchronization circuit that executes phase synchronization processing of the third clock signal based on a phase difference between the second clock signal and the third clock signal.

5. The transmission system according to claim 1, wherein
the second detecting circuit generates a second position signal that represents the positions from which the one or more empty slots have been deleted based on the detection result of the positions,
the restoration processing circuit includes
a second storing unit that stores the frame received from the first optical transmission apparatus, and
a second readout circuit that reads out the frame from the second storing unit, and
the second storing unit outputs pieces of empty data to the second readout circuit at the positions represented by the second position signal in reading-out of the frame.

6. The transmission system according to claim 1, wherein
the first optical transmission apparatus includes a generating circuit that generates the frame by causing the data signals to be accommodated in part of the plurality of slots, and
the first detecting circuit, the frame processing circuit, and the generating circuit are circuits set on a common circuit chip.

7. The transmission system according to claim 1, wherein
the second optical transmission apparatus includes an extracting circuit that extracts the data signals from part of the plurality of slots of the frame whose size has been returned to the size before deletion of the one or more empty slots by the restoration processing circuit, and
the second detecting circuit, the restoration processing circuit, and the extracting circuit are circuits set on a common circuit chip.

8. An optical transmission apparatus comprising:
a detecting circuit configured to detect one or more empty slots in which a data signal is not accommodated in a plurality of slots included in a frame;
a frame processing circuit configured to reduce size of the frame by deleting the one or more empty slots from the frame based on a detection result of the one or more empty slots and closing up gaps between remaining slots in the plurality of slots; and
an optical modulation processing circuit configured to carry out multi-level modulation of the frame at a bit rate according to size of the frame after reduction.

9. The optical transmission apparatus according to claim 8, wherein
the optical modulation processing circuit carries out multi-level modulation of the frame by probabilistic shaping.

10. The optical transmission apparatus according to claim 9, wherein
the detecting circuit generates a position signal that represents positions of the one or more empty slots in the frame based on the detection result of the one or more empty slots, and
the frame processing circuit includes
a storing unit that stores the frame from which the one or more empty slots have been removed based on the position signal, and
a readout circuit that reads out the frame from the storing unit.

11. The optical transmission apparatus according to claim 10, wherein
the detecting circuit deletes pulses according to time width of the one or more empty slots in the frame from a first clock signal that synchronizes with the frame input to the storing unit to generate a second clock signal,
the readout circuit reads out the frame from the storing unit in accordance with a third clock signal, and
the frame processing circuit includes a phase synchronization circuit that executes phase synchronization processing of the third clock signal based on a phase difference between the second clock signal and the third clock signal.

12. The optical transmission apparatus according to claim 8, further comprising:
a generating circuit configured to generate the frame by causing the data signals to be accommodated in part of the plurality of slots,
wherein
the detecting circuit, the frame processing circuit, and the generating circuit are circuits set on a common circuit chip.

13. A transmission method comprising:
detecting one or more empty slots in which a data signal is not accommodated in a plurality of slots by a first optical transmission apparatus;
reducing size of the frame by deleting the one or more empty slots from the frame based on a detection result of the one or more empty slots and closing up gaps between remaining slots in the plurality of slots by the first optical transmission apparatus;
carrying out multi-level modulation of the frame at a bit rate according to size of the frame after reduction by the first optical transmission apparatus;
detecting positions from which the one or more empty slots have been deleted in the frame received from the first optical transmission apparatus by a second optical transmission apparatus; and
returning the size of the frame to size before deletion of the one or more empty slots by inserting the one or more empty slots at the positions from which the one or more empty slots have been deleted in the frame based on a detection result of the positions by the second optical transmission apparatus.

14. The transmission method according to claim 13, wherein
processing of the carrying out multi-level modulation carries out u ti-level modulation of the frame by probabilistic shaping.

15. The transmission method according to claim 13, further comprising:
generating a first position signal that represents positions of the one or more empty slots in the frame based on the detection result of the one or more empty slots by the first optical transmission apparatus;
storing the frame from which the one or more empty slots have been removed based on the first position signal in a first storing unit by the first optical transmission apparatus; and
reading out the frame from the first storing unit by the first optical transmission apparatus.

16. The transmission method according to claim 15, further comprising:
deleting pulses according to time width of the one or more empty slots in the frame from a first clock signal that synchronizes with the frame input to the first storing unit to generate a second clock signal by the first optical transmission apparatus;
reading out the frame from the first storing unit in accordance with a third clock signal by the first optical transmission apparatus; and
executing phase synchronization processing of the third clock signal based on a phase difference between the second clock signal and the third clock signal by the first optical transmission apparatus.

17. The transmission method according to claim 13, further comprising:
generating a second position signal that represents the positions from which the one or more empty slots have been deleted based on the detection result of the positions by the second optical transmission apparatus;
storing the frame received from the first optical transmission apparatus in a second storing unit by the second optical transmission apparatus;
reading out the frame from the second storing unit by the second optical transmission apparatus; and
outputting pieces of empty data at the positions represented by the second position signal in reading-out of the frame by the second optical transmission apparatus.
